(19) United States
(12) Patent Application Publication
(10) Pub. No.: US 2012/0244494 A1
(43) Pub. Date: Sep. 27, 2012

(54) APPARATUS AND METHOD FOR REMOVING ENAMEL FROM A PERSON'S TOOTH

(76) Inventor: Carlos F. Navarro, Dallas, TX (US)

(21) Appl. No.: 13/071,070

(22) Filed: Mar. 24, 2011

(51) Int. Cl. A61C 3/06; B23P 17/00

(52) U.S. Cl. 433/118; 433/142; 433/215; 29/527.4

(57) ABSTRACT

According to one embodiment, an apparatus for removing enamel from a person's tooth includes a blade portion and an arch portion coupled to the blade portion. The blade portion includes an abrasive surface having a repeating pattern of recesses, and the abrasive surface is adapted to remove enamel from the tooth in response to reciprocating movement of the abrasive surface against the enamel.

### TECHNICAL FIELD

This invention relates generally to dentistry and orthodontics and in particular to an apparatus and method for removing enamel from a person's tooth.

### BACKGROUND

Many people experience adverse conditions resulting from the overcrowding of teeth associated with malocclusion. To avoid the need for one or more tooth extractions, such conditions have been treated effectively by removing enamel from one or more teeth in the person's mouth to create space or additional space. Interproximal Enamel Reduction (IER) is the clinical act of removing part of the enamel from an interproximal contact area of a person's tooth. To perform IER, an orthodontist or other clinical professional manually or mechanically files down the interproximal contact area of the tooth with a strip or disk made of steel or steel alloy with a diamond coating. Typically, over seven millimeters of space may be created between teeth in a person's upper arch, and over five millimeters of space may be created between teeth in a person's lower arch. In addition to creating space for orthodontic and other treatments, IER may be used to alter the size and shape of a person's teeth. Accordingly, IER often contributes to an improved finishing of orthodontic treatment and dental aesthetics. However, traditional steel files with diamond coatings lose grains during filing because the grains are smoothly anchored to the surface structure, which lowers the performance of the files over time. Furthermore, as the diamond coatings wear down, the files become less durable.

### OVERVIEW

The apparatus and methods of the present invention may reduce or eliminate certain problems and disadvantages associated with previous dental devices.

Particular embodiments of the present invention may provide one or more technical advantages. According to one embodiment, an apparatus for removing enamel from a person's tooth includes a blade portion and an arch. The blade portion includes an abrasive surface adapted to remove enamel from the tooth in response to reciprocating movement of the abrasive surface against the enamel. The blade portion is coupled to the arch portion, and the abrasive surface has a repeating pattern of recesses.

In certain embodiments, an apparatus for removing enamel from a person's tooth includes a blade portion that includes an abrasive surface adapted to remove enamel from the tooth in response to reciprocating movement of the abrasive surface against the enamel of the tooth. The abrasive surface may be formed through an etching process. In certain embodiments, the blade portion may be made of titanium, and the abrasive surface may be formed by removing material from the titanium blade portion.

Certain embodiments include a blade portion coupled to an arch portion and a handle portion coupled to the arch portion. The blade portion includes an abrasive surface that is adapted to remove enamel from teeth in response to reciprocating movement of the abrasive surface against the enamel of teeth. The abrasive surface has a repeating pattern of recesses. The handle portion may be coupled to a driver mechanism that drives reciprocating movement of the abrasive surface against the enamel of teeth.

Certain embodiments include an apparatus with an arch portion and a blade portion coupled to the arch portion. The blade portion includes an abrasive surface having a repeating pattern of recesses. Enamel from a tooth can be removed by positioning the apparatus proximate to the tooth and then moving the abrasive surface of the blade portion against the enamel of the tooth in a reciprocating motion.

In certain embodiments, the blade portion includes a polishing surface and an abrasive surface that has a repeating pattern of recesses. The blade portion also includes a coating. The repeating pattern of recesses and the polishing surface have been formed through processes that roughen the surface of the blade portion.

In certain embodiments, a repeating pattern of recesses may increase the abrasive effect of the blade portion and may lead to a more efficient removal of enamel from teeth. In certain embodiments, a polishing surface may increase the polishing effect of the blade portion and may lead to a smoother finish on the filed tooth. In certain embodiments, a coating may increase the hardness and durability of the blade portion. Certain embodiments may provide all, some, or none of these advantages. Certain embodiments may provide one or more other advantages, one or more of which may be apparent to those skilled in the art from the figures, descriptions, and claims included herein.

### BRIEF DESCRIPTION OF THE DRAWINGS

For a more complete understanding of the present invention and advantages thereof, reference is now made to the following description taken in conjunction with the accompanying drawings, in which:

FIGS. 1A-C illustrate example apparatuses for removing enamel from a person's tooth;

FIG. 2 illustrates an example apparatus for removing enamel from a person's tooth coupled to a driver mechanism.

FIGS. 3A-F illustrate example blades comprising abrasive surfaces having repeating patterns of recesses.

FIG. 4 illustrates an example method for removing enamel from a person's tooth;

FIG. 5 illustrates an example method of constructing an apparatus for removing enamel from a person's tooth;

FIG. 6A illustrates a cross section of an example blade comprising a coating, a polishing surface, and an abrasive surface that includes a repeating pattern of recesses.

FIG. 6B illustrates a cross section of an example blade comprising a coating, a polishing surface that includes a plurality of polishing grains, and an abrasive surface that includes a repeating pattern of recesses.

### DESCRIPTION OF EXAMPLE EMBODIMENTS

According to the present invention, an apparatus and method for removing enamel from one or more of a person's teeth are provided. The removal of enamel from one or both of two adjacent teeth may create space, or additional space, between the adjacent teeth. Thus, an IER procedure may be performed to prevent or treat the overcrowding of teeth associated with malocclusion and avoid the need for one or more tooth extractions. Additionally or alternatively, an IER procedure may be used to recontour or otherwise alter the size and shape of one or more of the person's teeth to provide a more aesthetically pleasing result.

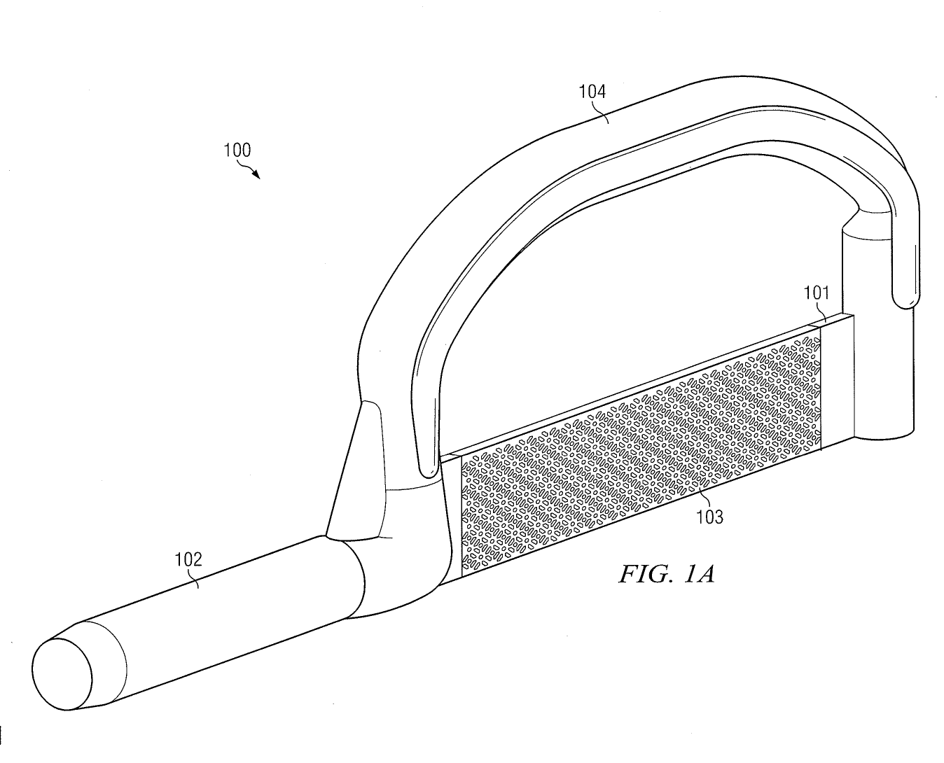

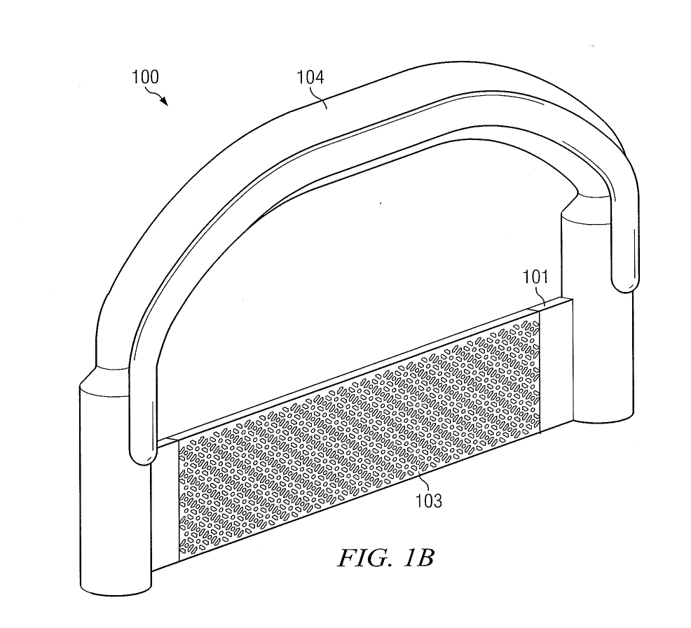

FIG. 1A-C illustrate example apparatuses 100 for removing enamel from a person's tooth. In FIG. 1A, apparatus 100 includes a handle 102, an arch 104 and a blade 101 with an abrasive surface 103. Handle 102 is coupled to arch 104. Blade 101 with abrasive surface 103 is coupled to arch 104. In FIG. 1B, apparatus 100 includes an arch 104 and a blade 101 with an abrasive surface 103 coupled to arch 104. Arch 104 may be gripped manually or mechanically by a clinical professional to control the movement of blade 101 during an IER procedure. In FIG. 1C, apparatus 100 includes a handle 102, an arch 104, a blade 101 with an abrasive surface 103, and a notch 105. Handle 102 is coupled to arch 104. Blade 101 with abrasive surface 103 is coupled to arch 104. Handle 102 includes notch 105 at the distal end of handle 102. Arch 104 and handle 102 may be covered with a coating of plastic or other suitable material. Notch 105 may be designed to improve the fit of apparatus 100 in a device or driver to control the movement of blade 101 during an IER procedure.

In certain embodiments, handle 102 may be formed from one piece of material. Handle 102 may be made of steel, titanium, or another metal. In certain embodiments, handle 102 may be formed from a plurality of materials. For example, handle 102 may comprise a metal core made from steel, titanium, or another metal and further comprise a coating or molding, made of plastic or another material, surrounding the metal core. Arch 104 may similarly be formed from one or multiple materials. For example, arch 104 may be made of steel, titanium, or another metal. Arch 104 may also comprise a metal core made from steel or titanium, and a coating or molding, made of plastic or another material, surrounding the metal core.

Apparatus 100 may be used to remove enamel from a person's tooth. For example, apparatus 100 may be used to remove enamel from one or both of two adjacent teeth in an IER procedure to create space, or additional space, between the adjacent teeth to prevent or treat overcrowding associated with malocclusion. As another example, apparatus 100 may be used to remove enamel from a tooth in an IER or other procedure to recontour the tooth to provide a more aesthetically pleasing shape. Accordingly, the recontouring of a tooth using apparatus 100 may contribute to an improved finish of orthodontic treatment. The present invention contemplates any appropriate use of apparatus 100 according to particular needs.

In certain embodiments, handle 102 may be gripped manually or mechanically by a clinical professional to perform IER or any other suitable procedure. An orthodontist or other clinical professional may use handle 102 to manually position apparatus 100 proximate the interproximal contact area of a person's tooth. As a result, the clinical professional using apparatus 100 may supply and control the force and motion necessary to advance abrasive surface 103 of blade portion 101 in opposing directions against the tooth.

In certain embodiments, the distal end of the handle 102 may be adapted to use a compression fit into a driver mechanism. A compression fit may be achieved by using a slightly flexible material for all or a portion of handle 102. The distal end may compress slightly or flex inward as it is inserted into a driver mechanism. The material then returns to its normal state to create the compression fit in the driver mechanism.

In certain embodiments, blade 101 includes one or more abrasive surfaces 103 adapted to remove enamel from a person's tooth when an abrasive surface 103 of blade 101 is repeatedly moved over or against the enamel of the tooth. For example, abrasive surface 103 may be repeatedly advanced in generally opposing directions with respect to the person's tooth in a manner that causes abrasive surface 103 to gradually remove enamel from the tooth. Such movement is referred to herein as “reciprocating” movement. In certain embodiments, abrasive surface 103 of blade 101 may be used to “file” or otherwise remove enamel from the person's tooth. In certain other embodiments, instead or in addition, abrasive surface 103 of blade 101 may be used to “saw” or otherwise remove enamel from the tooth.

In certain embodiments, blade 101 with abrasive surface 103 may be made of steel, titanium or another metal. In certain embodiments, blade 101 with abrasive surface 103 may be treated to improve performance of apparatus 100. For example, blade 101 with abrasive surface 103 may be coated to improve durability and hardness. In certain embodiments, abrasive surface 103 may include a repeating pattern of recesses and a plurality of polishing grains.

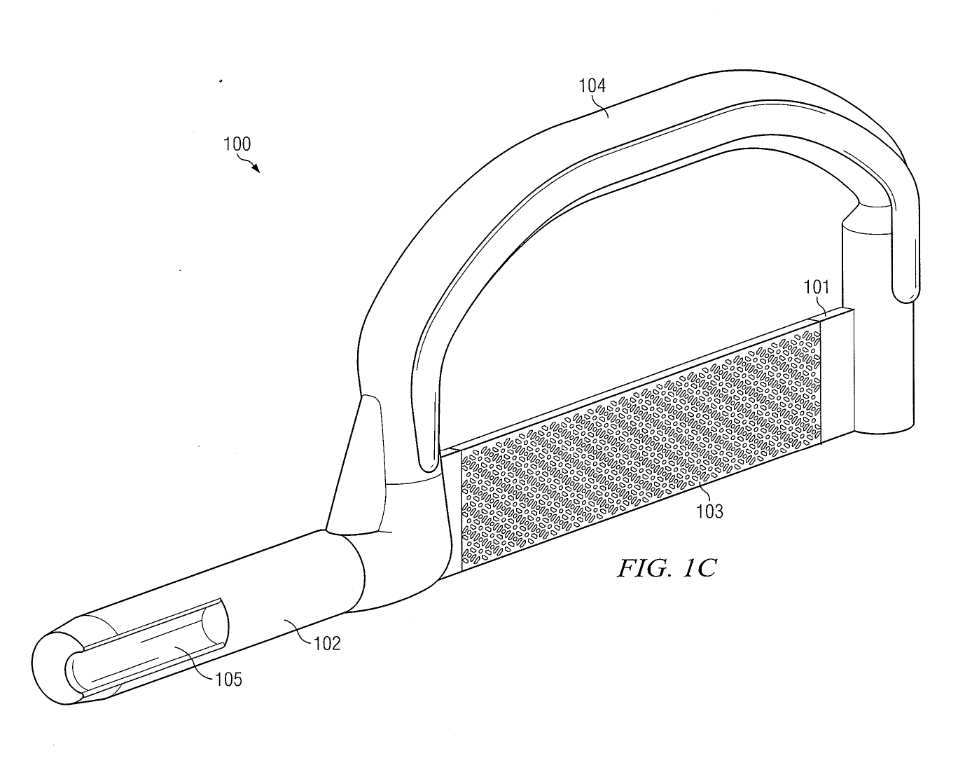

FIG. 2 illustrates an example apparatus 100 for removing enamel from a person's tooth coupled to a driver mechanism 106. Apparatus 100 may include a handle 102, an arch 104, and a blade 101 with abrasive surface 103. Handle 102 is coupled to arch 104, and blade 101 with abrasive surface 103 is coupled to arch 104. Handle 102 may be fitted to couple to driver mechanism 106. In a particular embodiment, handle 102, arch 104, and blade 101 may be formed from a single piece of titanium with a plastic coating surrounding at least portions of handle 102 and/or arch 104. In certain embodiments, handle 102 may include a notch that compresses to improve the fit of apparatus 100 to driver mechanism 106. Driver mechanism 106 drives reciprocating movement of apparatus 100 during an IER procedure such that blade 101 with abrasive surface 103 removes enamel from a person's tooth.

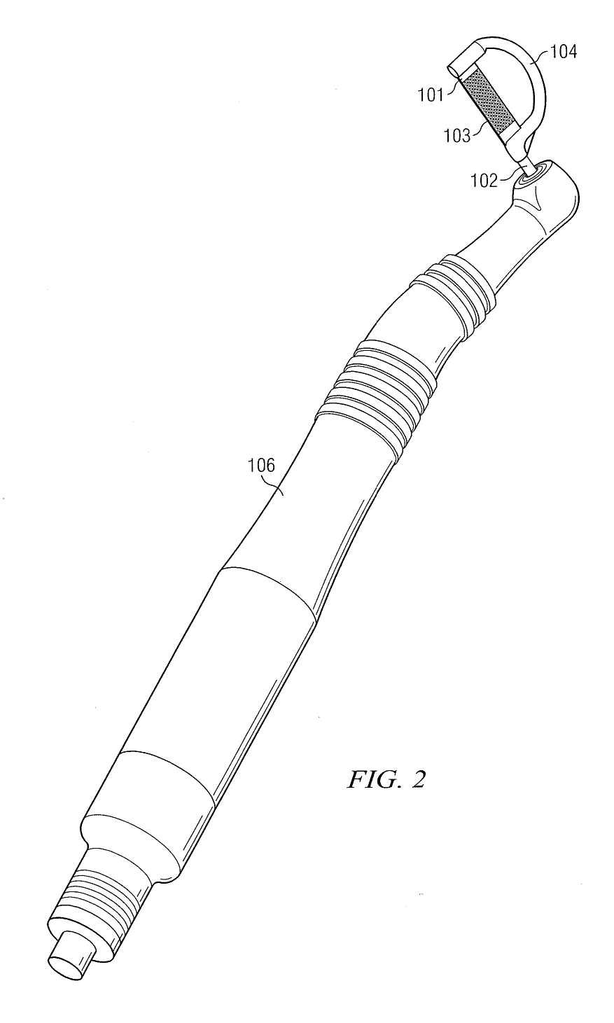

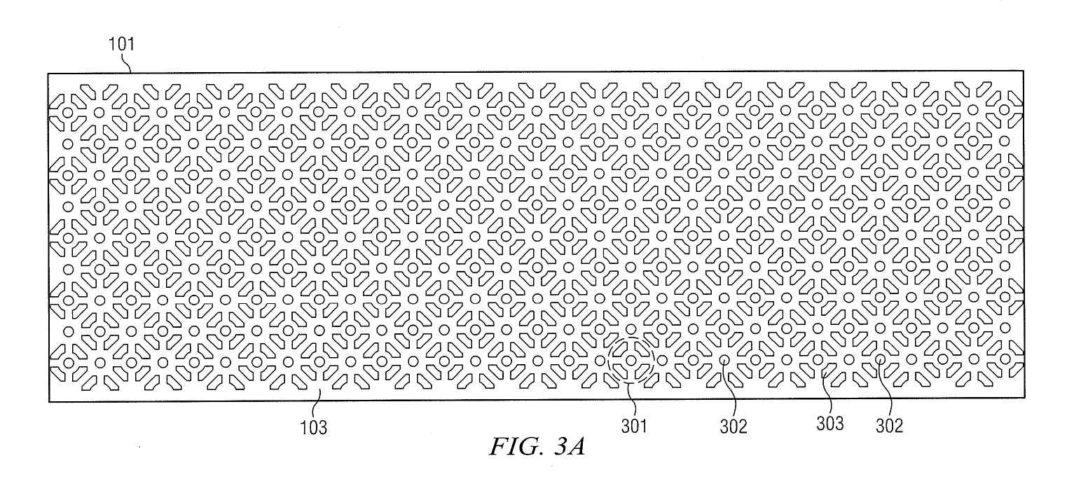

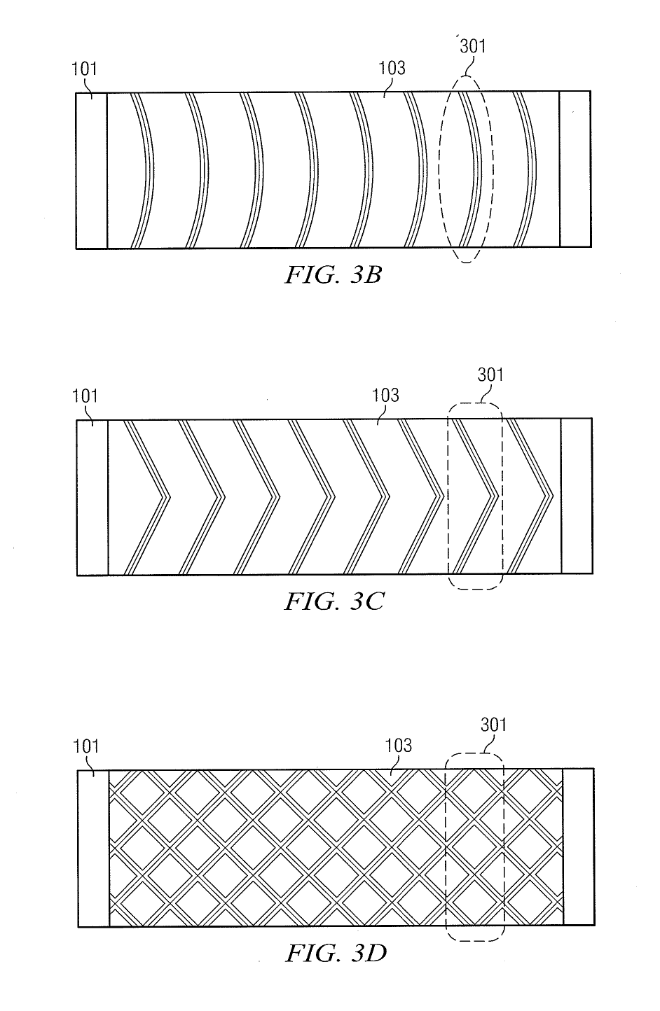

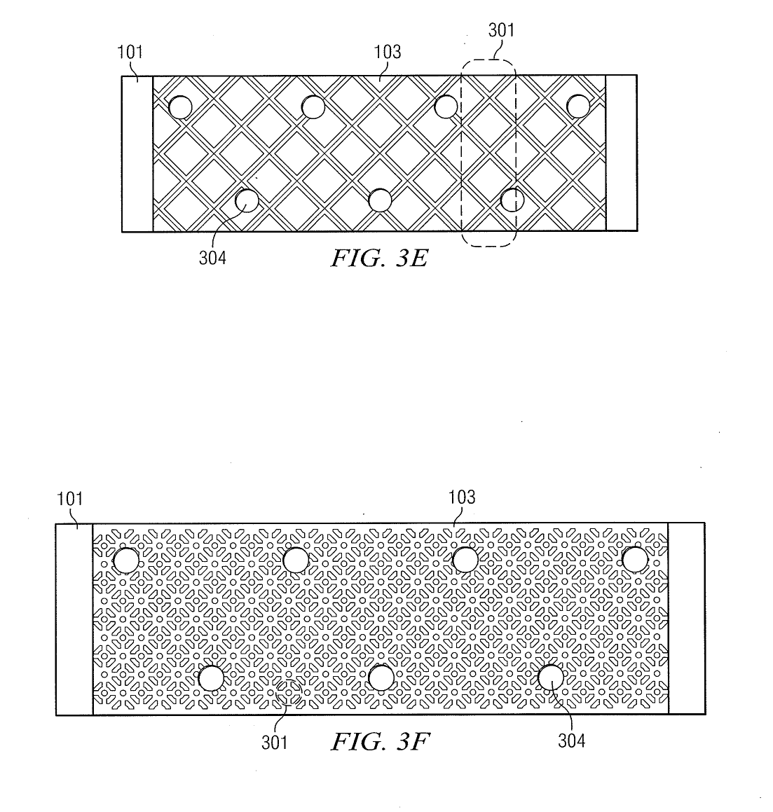

In certain embodiments, abrasive surface 103 may include a repeating pattern of recesses to improve the abrasive effect of blade 101. FIG. 3A-F illustrate example blades comprising abrasive surfaces having repeating patterns of recesses. In FIG. 3A, abrasive surface 103 of blade 101 contains an example floral lattice pattern of recesses. The example floral lattice pattern of recesses is formed by a repeating pattern 301 of circular recesses 302 surrounded by a plurality of trapezoidal recesses 303. Each repeating pattern 301 is separated from another repeating pattern by a separator recess 302. In FIG. 3B, abrasive surface 103 contains an example curved wave pattern of recesses. The example curved wave pattern of recesses is formed by a repeating pattern 301 of substantially curved recesses. In FIG. 3C, abrasive surface 103 contains an example pointed wave pattern of recesses. The pointed wave pattern of recesses is formed by a repeating pattern 301 of pointed recesses. In FIG. 3D, abrasive surface 103 contains an example cross-hatch pattern of recesses. The example cross-hatch pattern of recesses is formed by a repeating pattern 301 of linear recesses in a criss-cross pattern. When abrasive surface 103 with a repeating pattern of recesses is moved across the surface of a tooth, the repeating pattern of recesses provides a more secure and improved abrasive effect against the surface of the tooth.

In certain embodiments, blade 101 includes one or more apertures for channeling debris away from the tooth. For example, apertures may comprise substantially circular openings. FIG. 3E illustrates an example blade 101 with a plurality of apertures 304 combined with an abrasive surface 103 that contains an example cross-hatch pattern of recesses formed by a repeating pattern 301 of linear recesses in a criss-cross pattern. FIG. 3F illustrates an example blade 101 with a plurality of apertures 304 combined with an abrasive surface 103 that contains an example floral lattice pattern of recesses. As blade 101 is advanced against the tooth and enamel is gradually removed, the IER procedure may result in the accumulation of debris in and around the interproximal contact area. The accumulated debris may include, for example, bits of removed enamel, saliva, blood and any liquids, chemicals, or pastes used in the IER procedure. Apertures 304 of blade 101 may act to channel such debris away from the interproximal contact area such that abrasive surface 103 remains against the interproximal contact area for more accurate enamel removal. Additionally, the patient's mouth may be kept cleaner as the IER procedure is being performed, without undue interruption.

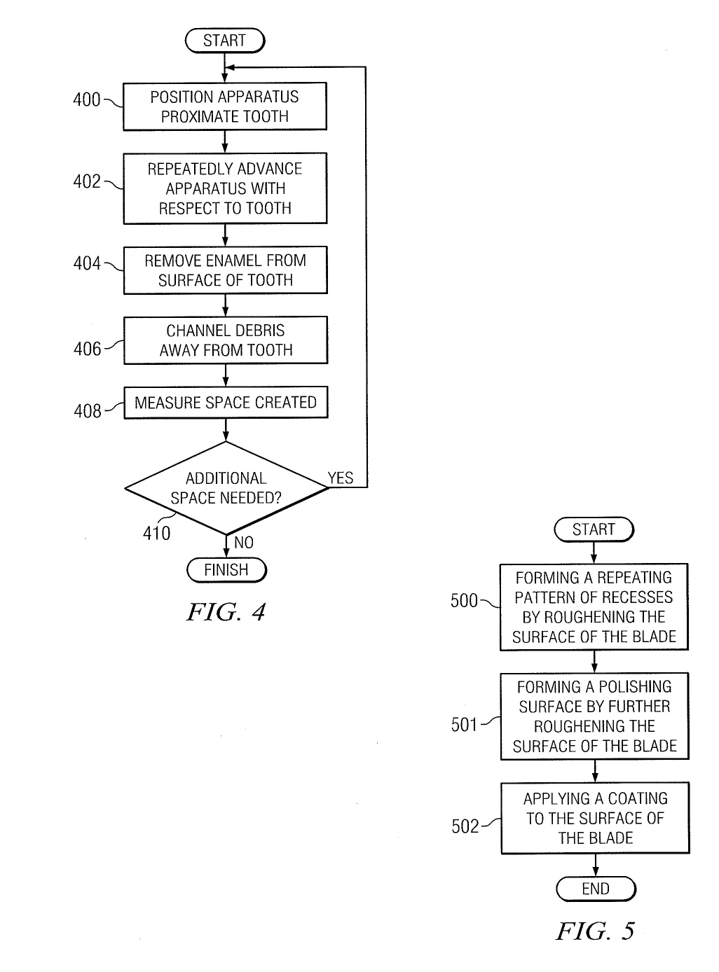

FIG. 4 illustrates an example method for removing enamel from a person's tooth. The method may include some or all of an IER procedure. At step 200, apparatus 100 is positioned proximate a particular tooth of a person's upper or lower arch. Specifically, abrasive surface 103 may be positioned proximate an interproximal contact area of the tooth. At step 202, apparatus 100 is repeatedly advanced in opposing directions with respect to the tooth. Apparatus 100 may be advanced in opposing directions with respect to the tooth in a first direction towards the labial surface of the tooth and in a second direction towards the lingual surface of the tooth. As a result, at step 204, abrasive surface 103 may file, saw, or otherwise remove enamel from the tooth. Enamel may be removed in a similar manner from an adjacent tooth. As a result of enamel being removed from one or both adjacent teeth, a space or additional space is created between the adjacent teeth to prevent or treat overcrowding of teeth associated with malocclusion and to avoid the need for tooth extractions. Alternatively or additionally, enamel may be removed from the tooth to provide a more aesthetically pleasing shape.

At step 206, as enamel is removed from the tooth, in certain embodiments debris is channeled away from the tooth through one or more apertures formed through blade portion 101. The debris present at the interproximal area may include, for example, bits of removed enamel, saliva, blood, and any liquids, chemicals or pastes used in the IER procedure. As a result, such debris may be readily removed from the interproximal area and the area kept cleaner and visibly unobstructed during an IER procedure, without undue interruption.

At step 208, the space created between the adjacent teeth is measured. The amount of space to be created depends on the amount of overcrowding, the desired shape and size of the tooth, and other factors particular to the person. At step 210, the clinical professional determines whether additional space is needed. If additional space is needed, the method returns to step 200 for removal of additional enamel 110. The method may continue by repeating steps 200-210 on the same tooth or on an adjacent tooth until the desired amount of space is created. When it is determined at step 210 that additional space is not needed, the method ends.

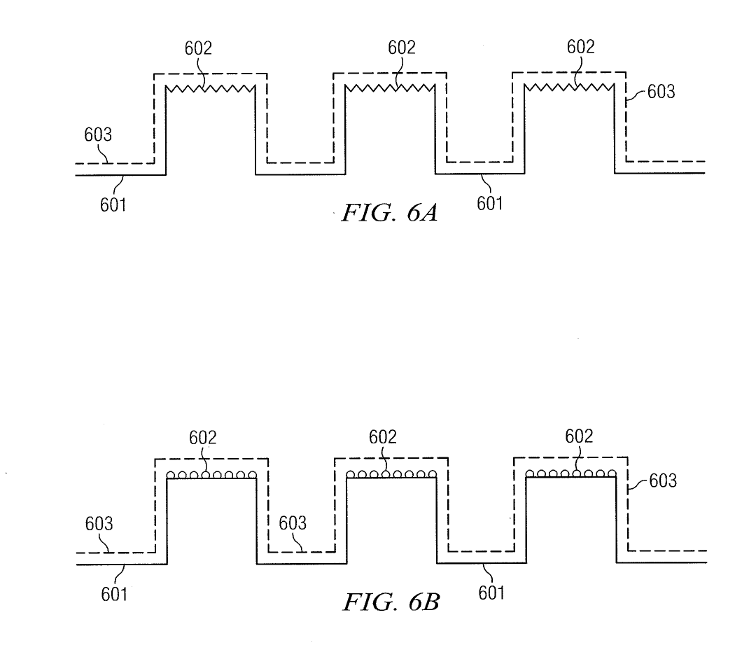

FIG. 5 illustrates an example method of constructing an apparatus for removing enamel from a person's tooth. FIGS. 6A and 6B illustrate cross sections of an example blade 101 comprising a coating 603, a polishing surface 602, and an abrasive surface 103 having a repeating pattern of recesses 601. At step 500, a repeating pattern of recesses 601 is formed in blade 101 by roughening the surface of blade 101. At step 501, a polishing surface 602 is formed in blade 101 by further roughening the surface of blade 101. Forming the polishing surface may be through a subtractive or an additive process. For example, polishing surface 602 in FIG. 6A may be formed by removing portions of the surface of blade 101, whereas polishing surface 602 in FIG. 6B may be formed by applying a plurality of polishing grains to the surface of blade 101. The repeating pattern of recesses 601 may improve the abrasive effect of abrasive surface 103, while the polishing surface 602 may improve the polishing effect of blade 101. Repeating pattern of recesses 601 can be applied to the surface of blade 101 through methods such as mechanical stamping, laser working, sandblasting, and acid etching or a combination thereof.

During mechanical stamping, a press with a die may be used to shape or cut the surface of blade 101. The process may have a purely surface structuring function. The resulting topological structure may correspond with the appropriate choice of shape and material for the die. For example, a die may be used to press a pattern of recesses 601 into the surface of blade 101 while another die may be used to press a plurality of polishing grains 602 onto the surface of blade 101. The resulting abrasive surface 103 has preferably a roughness with a magnitude of 30 microns to 150 microns for abrasion (e.g. by the repeating pattern of recesses) and a magnitude of 5 microns to 15 microns for polishing (e.g. by the polishing surface).

Laser working may harden the surface of blade 101. Application of a laser beam may rapidly raise the surface temperature such that a thin layer is converted into austenite. Removal of the energy may result in self quenching by conduction of the heat into the relatively cool bulk, which may produce a rapidly cooled surface layer and transform the austenite into martensite. One possible benefit of laser hardening is an improvement of wear resistance. Abrasive wear may be reduced due to laser hardened surfaces exhibiting a lower coefficient of friction and/or a higher hardness than the abrasive medium. Laser hardening may also improve the fatigue characteristics of surfaces.

During sand blasting the surface of blade 101 may be blasted with abrasive particles at a high pressure to shape the surface of blade 101. For example, alumina particles may be used to carve a pattern of recesses 601 into blade 101 or to cut a polishing surface 602 onto the surface of blade 101. The treatment may use a pressure between about 1 bar and 10 bar, or between 1 bar and 6 bar.

Acid etching may use one or more of various chemicals. For example, one or more of HCl, H₂SO₄, NOH₃, and/or H₂PO₄, in various concentrations may be used. In particular embodiments, a mixture of nitric acid and hydrochloric acid, or a mixture of sulphuric acid, nitric acid, and hydrochloric acid in different concentrations and proportions may be used. In certain embodiments, the etching may be carried out over a period of thirty seconds to thirty hours. In particular embodiments, the etching may be carried out over a period of 0.01 to five hours or from about 0.01 to two hours. In certain embodiments, the etching may be at a temperature of 20° Celsius to 260° Celsius. In certain embodiments, the etching may be at a temperature from 40° Celsius to 100° Celsius or from about 60° Celsius to 80° Celsius. An etching treatment may conclude with a cleaning step such as in ultrasound with pure deionized water, by washing in deionized water, and/or by rinsing in deionized water. Acid etching may be used to etch repeating pattern of recesses 601 into the surface of blade 101.

At step 502, coating 603 is applied to the surface of blade 101. Coating 603 may be of metal and/or other suitable material. Coating 603 may be applied through physical vapor deposition (PVD), or chemical vapor deposition (CVD). Physical vapor deposition is characterized by the creation of a vapor that can be reacted with different gasses to form a thin film coating. Coating 603 can comprise titanium nitride, chromium carbonitride, titanium carbonitride, zirconium nitride, or TiAlCrYN. Coating thicknesses may range from 2 to 5 microns. In particular embodiments, coatings may be as thin as 0.5 microns or as thick as 15 or more microns.

Chemical vapor deposition is characterized by the creation of a coating through a chemical reaction. During chemical vapor deposition, the surface of blade 101 may be reacted with a chemical to produce coating 603. The surface of blade 101 may also be treated with a reactant prior to exposure to the chemical to produce coating 603. A form of chemical vapor deposition is plasma assisted chemical vapor deposition (PACVD). The thickness of the coating may be 2 to 3 microns and may be deposited in a cycle time of around 3.5 hours.

In certain embodiments, applying a coating 603 to the surface of blade 101 may increase the surface hardness and/or may increase the durability of the surface. In certain embodiments, applying coating 603 to the surface of blade 101 may reduce or eliminate the wear on polishing surface 602 during operation, and therefore may allow blade 101 to perform consistently over a period of time. For example, in certain embodiments, polishing surface 602 may comprise a plurality of polishing grains, and coating 603 may reduce or eliminate the loss of polishing grains during operation.

Although example steps are illustrated and described, the present invention contemplates two or more steps taking place substantially simultaneously or in a different order. For example, step 500, forming a repeating pattern of recesses, may be performed after step 501, forming a polishing surface. Furthermore, step 502, applying a coating, may be performed prior to step 500 or step 501. In addition, the present invention contemplates using methods with additional steps, fewer steps, or different steps, so long as the steps remain appropriate for removing enamel from a person's tooth to create additional space in the person's mouth to treat or prevent malocclusion, to recontour the tooth to create a more aesthetically pleasing shape, or to treat any other condition that may be improved through the reshaping or resizing of the person's tooth.

Although the present invention has been described above in connection with several embodiments, changes, substitutions, variations, alterations, transformations, and modifications may be suggested to one skilled in the art, and it is intended that the present invention encompass such changes, substitutions, variations, alterations, transformations, and modifications as fall within the spirit and scope of the appended claims.

1-37. (canceled)

38. A method of constructing an apparatus for removing enamel from a person's tooth comprising:
forming a repeating pattern of recesses in a surface of a blade portion of the apparatus by roughening the surface of the blade portion;
forming a polishing surface by removing material from the surface of the blade portion; and
applying a coating to the blade portion.

39. The method of claim 38 wherein the repeating pattern of recesses forms a floral lattice pattern.

40. The method of claim 38 wherein forming the repeating pattern of recesses comprises at least one of mechanical stamping and sandblasting.

41. The method of claim 38 wherein the repeating pattern of recesses has a roughness of 30 microns to 150 microns.

42. The method of claim 38 wherein the polishing surface has a roughness of 5 microns to 15 microns.

43. (canceled)

44. The method of claim 38 wherein coating is applied through physical vapor deposition.

45. The method of claim 44 wherein the coating has a thickness of 2 microns to 5 microns.

46. The method of claim 44 wherein the coating has a thickness of at least 0.5 microns.

47. The method of claim 44 wherein the coating has a thickness of at least 15 microns.

48. The method of claim 38 wherein the coating is applied through chemical vapor deposition.

49. The method of claim 48 wherein the chemical vapor deposition is plasma assisted chemical vapor deposition.

50. The method of claim 48 wherein the coating has a thickness of 2 to 3 microns.

51. (canceled)

52. The method of claim 38 wherein forming the repeating pattern of recesses comprises laser working.

53. The method of claim 38 wherein forming the repeating pattern of recesses comprises acid etching.

54. A method of constructing an apparatus for removing enamel from a person's tooth comprising:
forming an abrasive surface on a blade portion of the apparatus through an etching process, wherein the abrasive surface is adapted to remove enamel from a tooth in response to reciprocating movement of the abrasive surface against the enamel of the tooth.

55. A method of constructing an apparatus for removing enamel from a person's tooth comprising:
forming an abrasive surface on a titanium blade portion of the apparatus by removing material from the titanium blade portion, wherein the abrasive surface is adapted to remove enamel from a tooth in response to reciprocating movement of the abrasive surface against the enamel of the tooth.
